(19) United States
(12) Patent Application Publication
(10) Pub. No.: US 2022/0136767 A1
(43) Pub. Date: May 5, 2022

(54) Method and Device for Continuously Drying Bulk Goods

(71) Applicant: L.B. Bohle Maschinen und Verfahren GmbH, Ennigerloh (DE)

(72) Inventors: Andreas Altmeyer, Münster (DE); Robin Meier, Dortmund (DE); Lorenz Bohle, Ennigerloh (DE)

(21) Appl. No.: 17/431,166

(22) PCT Filed: Jan. 8, 2020
(86) PCT No.: PCT/EP2020/050241

§ 371 Date: Aug. 15, 2021

(30) Foreign Application Priority Data
Mar. 8, 2019 (DE) 10 2019 106 026.5

(51) Int. Cl. F26B 17/26; F26B 3/06; F26B 25/00; B01D 46/71; B01D 46/76

(52) U.S. Cl. CPC F26B 17/26; F26B 3/06; F26B 2200/08; B01D 46/71; B01D 46/76; F26B 25/007

(57) ABSTRACT

The invention relates to a method for drying moist products, in particular moist granules for producing pharmaceutical products through which a fluid medium flows in a reactor chamber of a bulk goods dryer and which are heated and placed on a fluid medium-permeable inflow base. The inflow base is vibrated via a vibrational drive in order to convey the products from a product inlet to a product outlet, and the fluid medium is supplied to separate chambers arranged upstream of an outlet and to the outlet after flowing through the inflow base and the product. One of the at least two separate chambers is preselectably closed off from the outlet by actuating a closing element such that after the closing element has been actuated, the supply of the fluid medium to the outlet is carried out via a chamber which is not closed by another closing element, and a fluid medium filter element paired with the closed chamber is cleaned via a pulse emitter after the closing element of said chamber is actuated in the closing direction while the fluid medium is continuously supplied to a non-closed chamber.

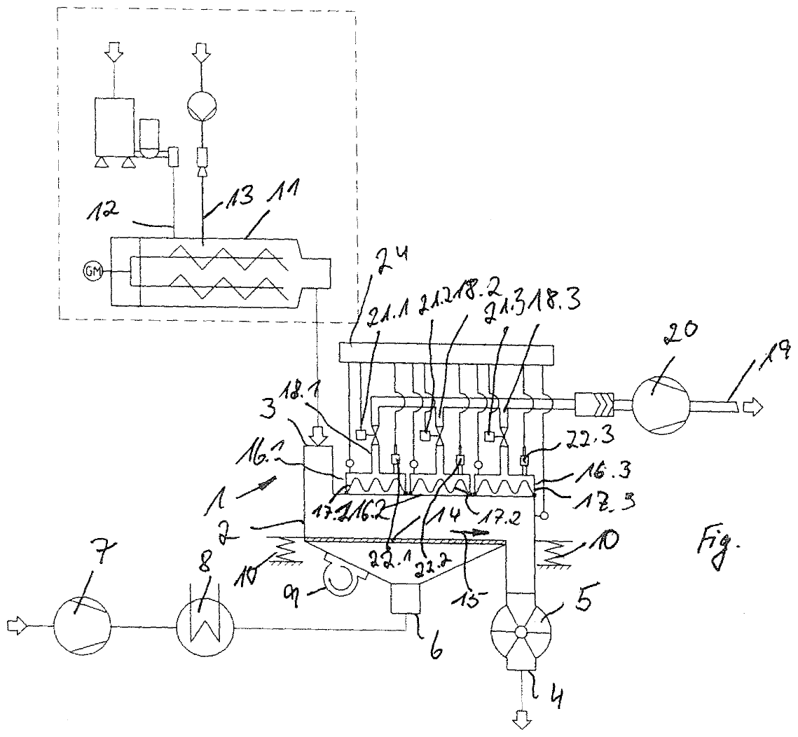

The invention relates firstly to a method for drying moist products, in particular moist granular material for producing pharmaceutical products that, in a reactor chamber of a bulk goods dryer, is supplied to an inflow bottom, through which a fluid medium can flow, and that is flowed through and heated by the fluid medium, wherein the inflow bottom by means of a vibration drive is caused to vibrate for conveying the product from a product inlet to a product outlet, and the fluid medium, after flowing through the inflow bottom and the product, is supplied to chambers, separated from each other and arranged upstream of an outlet, and to the outlet.

Moreover, the invention concerns a bulk goods dryer for performing the method, with a reactor chamber provided in a container through which a fluid medium can flow, wherein the reactor chamber comprises a fluid medium-permeable inflow bottom, in particular of a fine fabric and/or stainless steel material, and the container is provided with a product inlet and a product outlet, wherein the product in the reactor chamber can be acted upon by the fluid medium and the reactor chamber comprises an outlet for the fluid medium, wherein the reactor chamber, in flow direction for the fluid medium above the inflow bottom, comprises at least two chambers positioned adjacent to each other and arranged upstream of an outlet for the fluid medium, and the inflow bottom by means of a vibration drive can be caused to vibrate for conveying the product from the product inlet to the product outlet.

Bulk goods dryers are used for various tasks, e.g. to produce and dry granular material for the pharmaceutical industry, e.g. for the subsequent processing to pharmaceutical tablets. Moreover, there are numerous further applications for such bulk goods dryers in order to dry moist starting material and/or, for example, to subsequently coat a solid material. Increasingly, such bulk goods dryers are continuously operated but can also work discontinuously.

DE 296 11 972 U1 discloses a device and a method for drying bulk goods of the aforementioned kind. In this context, from a storage container the moist granular material to be dried is supplied to an inflow bottom which, by means of a vibration drive, is caused to vibrate so that the bulk goods or granular material to be dried can be conveyed to a product outlet. Above the inflow bottom, various chambers are arranged in which, in vertical orientation, filter cartridges can be arranged. In a first inflow region, air heated by means of a heating device is supplied to the bulk goods. A further inflow region can be correlated with the first inflow region. The heated air flow, after passing the product stream and the corresponding filter elements, can be supplied to a common outlet for the fluid medium. In further regions, a cooling zone may adjoin by means of which cooling air can be supplied to the conveyed product stream. A disadvantage in this context is that, for a continuous operation of such a method and such a device, the filter cartridges very quickly exhibit only a minimal effect because the filter materials clog very quickly. This requires a time-consuming exchange of the filter cartridge.

It is object of the present invention to propose a method and a bulk goods dryer for performing the method which are suitable, with a high degree of efficiency, to make available even a continuous drying of a moist granular material in particular for the pharmaceutical industry.

For solving this object, the method of the aforementioned kind is characterized in that one of the at least two chambers that are separated from each other is closed, preselectably, toward the outlet by actuation of a shut-off member, in that, after actuation of the shut-off member, the supply of the fluid medium to the outlet is realized via a chamber that is not closed by another shut-off member, and in that a filter element for the fluid medium correlated with the chamber that is shut off, after actuation of the shut-off member of this chamber in the closing direction, is purified by means of an impulse generator, e.g. an ultrasonic generator, with continued supply of the fluid medium to a chamber that is not shut off.

In this way, firstly a method is provided with which moist products, in particular moist granular material for producing pharmaceutical products, can be excellently dried in a continuously working process, even when it must exit as a very fine dried powder from the bulk goods reactor. For cleaning filter elements, the method must not be interrupted because the fluid medium, that is e.g. heated air, can be guided in purified form to the outlet via at least one chamber open toward the outlet for the fluid medium with the filter element correlated with this chamber. The purification of the filters of the individual chambers, thus for the smallest device with two chambers, preferably however three or more chambers, the individual filter elements can be purified sequentially and temporarily alternately by an impulse generator correlated respectively with the filter element, such as an ultrasonic generator, compressed air generator or similar vibration generator. This can be realized in predetermined time intervals, for example, by a control unit.

The respective shut-off members are actuated in parallel so that an impulse generator is activated only once the shut-off member of its chamber is closed. The then activated impulse generator generates corresponding vibrations at the filter element so that particles adhering thereto detach and fall down into the product stream within the reactor chamber on the inflow bottom. This purification of the filter elements can be performed with a high degree of efficiency. The continuous drying process is not at all impaired by the alternate cleaning cycles of the respective filter elements. This leads to a high drying performance with minimal and hardly measurable product losses and non-contaminated exhaust air.

The filter elements for this purpose are preferably embodied as individual filter elements and are spanned across at the inlet of each chamber so that they extend substantially parallel to the inflow bottom. They can have different structures and geometries. In the simplest case, a spanned across filter element suffices that extends within the inlet opening of a chamber that is, for example, of a square or rectangular configuration so that the filter element can be inserted into this square or rectangular opening of the chamber.

Preferably, a filter element is elastically supported at the chamber walls. The filter elements can however also have a different cross section structure in order to enlarge the filter surface. Thus, they can be angled in opposite direction across their longitudinal and transverse extensions with oppositely e.g. rounded elevations and depressions, but also comprise other geometries that enlarge the filter surface.

Preferably, the product that is to be supplied to the bulk goods dryer is supplied by a twin screw granulator which has an inlet for a powder product starting material and an inlet for a liquid. At the outlet side, the product can be discharged by a rotary valve from the bulk goods dryer.

A bulk goods dryer or a device for performing the method according to the invention is characterized in that each of the chambers has correlated therewith a shut-off member and the chamber can be opened and closed for flow of the fluid medium, wherein, through the chamber that is closed for a flow therethrough of the fluid medium by the shut-off member, a respective other chamber is opened or remains open by the shut-off member correlated with this chamber, wherein each chamber has correlated therewith an impulse generator such as e.g. an ultrasonic generator and a filter element and the filter element of the chamber can be purified via the impulse generator of this chamber with closed shut-off member of this chamber.

Due to the interval-based but always performed purification of the individual filter elements, the latter operate extremely efficiently and have a long service life. No blocking in the respective filter elements occurs. Due to the impulse generators (e.g. ultrasonic generator), product residues are supplied to the product stream from the filter elements.

With respect to further embodiments of the invention, reference is being had to further dependent claims. Moreover, reference is being had to the following description for further explanation of the invention and the following drawing. In the Fig., an embodiment of a bulk goods dryer is illustrated with which the method according to the invention can be performed.

In general, 1 refers to the bulk goods dryer which comprises a reactor chamber 2 with a product inlet 3 and a product outlet 4, which has arranged upstream thereof a rotary valve 5. The reactor chamber 2 has a further inlet 6 through which heated air can be supplied, which is supplied by a blower 7 to a heating device 8 and is then supplied to the inlet 6.

By means of a vibration drive 9, the reactor 2 can be vibrated. In this context, this is a vibration generating motor which can cause the inflow bottom 14 to vibrate in length vibrations and optionally also transverse vibrations. The reactor is supported in a springy fashion, namely by spiral springs 10. A twin screw granulator 11 with two inlets, namely on the one hand an inlet 12 for a powder starting product and an inlet 13 for a liquid, is arranged upstream of the product inlet 3. Both together are processed in the twin screw granulator 11 to a moist product, thus a moist granular material, and can thus be supplied to the bulk goods dryer 1. It is supplied onto the inflow bottom 14 which is caused to perform vibrating movements by the vibration drive 9 and which conveys the granular material that is to be dried and is dried in the conveying direction 15 to the outlet 4.

The inflow bottom 14 is embodied permeable to air so that on it a fixed bed forms with simultaneous conveyance in the direction of the arrow 15 but can also vibrate in transverse direction thereto. This leads to the product to be dried to be flowed through extremely efficiently by the introduced heated air.

Above the inflow bottom 14 in the illustrated embodiment, three chambers are provided, namely the chamber 16.1, the chamber 16.2, and the chamber 16.3. Each of these chambers has correlated therewith a separate filter element so that as whole three filter elements are provided, namely the filter elements 17.1, 17.2, and 17.3. These filter elements span across the entire inlet of the chambers 16.1, 16.2, and 16.3 and are embodied, oppositely curved or angled, with elevations and depressions so that a very large filter surface results in relation to the dimensions of the inlet of the respective chamber 16.1, 16.2 and 16.3. Within the inlets of the chambers 16.1, 16.2 and 16.3, they are elastically connected to the chamber walls and have a frame receiving the filter materials for this purpose.

The respective chambers 16.1, 16.2, and 16.3 each have outlets 18.1, 18.2, 18.3 for the fluid medium to be discharged, which are all correlated with an outlet 19 that has arranged upstream thereof a blower 20. Each of these outlets 18.1, 18.2, 18.3 has a shut-off member 21.1, 21.2, and 21.3. In addition, an ultrasonic generator is provided for each filter element 16.1, 16.2, and 16.3, respectively, namely the ultrasonic generators 22.1, 22.2, and 22.3 which are centrally controlled by a control unit 24 so that a purification of a filter element 17.1 or 17.2 or 17.3 is realized when the respective shut-off member 21.1, 21.2 or 21.3 of the respective chamber 16.1, 16.2 or 16.3 is closed, whereupon the ultrasonic generator 22.1, 22.2, 22.3 correlated with this chamber is activated and the respective filter element 17.1, 17.2 or 17.3 is caused to vibrate. This is realized respectively in a cyclic fashion sequentially and therefore alternately in predetermined operating intervals so that the continuous operation can be continued but one chamber 16.1, 16.2 or 16.3, respectively, is removed from operation by closing the correlated shut-off member, whereupon then the corresponding filter element 17.1, 17.2 or 17.3 is purified. When, for example, the chamber 16.1 is switched off, the supplied air is supplied through the two other chambers 16.2 and 16.3 to the outlet 19.

Moreover, a control unit can be provided in order to control the interior pressure in the reactor chamber 2 as a function of predetermined operating parameters. This concerns the control of the interior pressure above the inflow bottom 14 and below the filter elements 17.1, 17.2, and 17.3.

What is claimed is:

1.-32. (canceled)

33. A method for drying a product with a fluid medium in a bulk goods dryer, wherein the bulk goods dryer comprises a reactor chamber with a product inlet, a product outlet, a fluid medium-permeable inflow bottom, and a vibration drive configured to vibrate the fluid medium-permeable inflow bottom, wherein the bulk goods dryer comprises at least two chambers separated from each other and arranged upstream of a fluid medium outlet, wherein the at least two chambers each have a shut-off member and a filter element correlated therewith; the method comprising:
supplying the product via the product inlet to the fluid medium-permeable inflow bottom;
heating the fluid medium and passing the heated fluid medium through the fluid medium-permeable inflow bottom and through the product on the fluid medium-permeable inflow bottom;
vibrating the fluid medium-permeable inflow bottom with the vibration drive to convey the product from the fluid medium-permeable inflow bottom to the product outlet;
supplying the fluid medium, after flowing through the fluid medium-permeable inflow bottom and through the product on the fluid medium-permeable inflow bottom, via the at least two chambers to the fluid medium outlet;
preselectably closing a first one of the at least two chambers toward the fluid medium outlet by actuating the shut-off member of said first chamber in a closing direction to shut off said first chamber and continuing a supply of the fluid medium to the fluid medium outlet via at least a second one of the at least two chambers that is not shut off by actuating the shut-off member of said at least one second chamber;
purifying the filter element correlated with said first chamber that is shut off by an impulse generator while continuing the supply of the fluid medium to the fluid medium outlet via said at least one second chamber;
controlling by a control device a pressure in the bulk goods dryer above the fluid medium-permeable inflow bottom and below the filter elements as a function of predetermined operating parameters.

34. The method according to claim 33, wherein the impulse generator is an ultrasonic generator or a compressed air generator.

35. The method according claim 33, further comprising supplying the fluid medium, prior to entering the fluid medium outlet, to the filter elements correlated with the at least two chambers, wherein the filter elements each are flowed through by the fluid medium, independent of the filter element of another one of the chambers, when the shut-off member of the respective chamber is not actuated in the closing direction.

36. The method according to claim 33, wherein the at least two chambers each have an impulse generator correlated therewith, wherein the impulse generators are ultrasonic generators, wherein each one of the filter elements is purified by the correlated ultrasonic generator when the correlated shut-off member has been actuated in the closing direction.

37. The method according to claim 36, further comprising alternately actuating for a time interval the correlated shut-off members of the at least two chambers in the closing direction and activating for said time interval, after actuating the correlated shut-off member in the closing direction, the correlated ultrasonic generator to purify the filter element.

38. The method according to claim 33, further comprising vibrating the fluid medium-permeable inflow bottom in a conveying direction of the product and transverse to the conveying direction of the product.

39. The method according to claim 33, further comprising providing a twin screw granulator, supplying a powder product starting material via a first inlet to the twin screw granulator and supplying a liquid via a second inlet to the twin screw granulator to produce a moist granular material, wherein the first inlet and the second inlet are separate from each other, and supplying the moist granular material as the product to be dried to the bulk goods dryer.

40. The method according to claim 33, further comprising suppling the product via a rotary valve to the product outlet.

41. A bulk goods dryer for performing the method according to claim 33, the bulk goods dryer comprising:
a reactor chamber comprising a fluid medium-permeable inflow bottom, a product inlet, a product outlet, a fluid medium inlet, and a fluid medium outlet, wherein the reactor chamber is configured to be flowed through by a fluid medium in a flow direction from the fluid medium inlet through the fluid medium-permeable inflow bottom to the fluid medium outlet, and wherein a product in the reactor chamber is acted on by the fluid medium flowing through the reactor chamber;
at least two adjacently arranged chambers arranged in a flow direction of the fluid medium above the fluid medium-permeable inflow bottom and upstream of the fluid medium outlet;
a vibration drive connected to the fluid medium-permeable inflow bottom and configured to vibrate the fluid medium-permeable inflow bottom to convey the product to the product outlet;
wherein the at least two chambers each have correlated therewith a filter element, an impulse generator, and a shut-off member configured to open and shut off a flow of the fluid medium through the correlated chamber;
wherein, when a first one of the at least two chambers is shut off by the correlated shut-off member in the flow direction toward the fluid medium outlet, the fluid medium is supplied to the fluid medium outlet through at least a second one of the at least two chambers that is not shut off in the flow direction toward the fluid medium outlet by the correlated shut-off member, and the filter element of said first chamber is vibrated by the impulse generator of said first chamber;
a control unit configured to control an interior pressure within the bulk goods dryer above the fluid medium-permeable inflow bottom and below the filter elements as a function of predetermined operating parameters.

42. The bulk goods dryer according to claim 41, wherein the impulse generators of the at least two chambers are ultrasonic generators or compressed air generators.

43. The bulk goods dryer according to claim 41, wherein the at least two chambers each comprise a chamber outlet that opens into the fluid medium outlet, wherein the shut-off members are arranged at the chamber outlets.

44. The bulk goods dryer according to claim 41, wherein the filter elements of the at least two chambers extend parallel to the fluid medium-permeable inflow bottom.

45. The bulk goods dryer according to claim 44, wherein the filter elements of the at least two chambers are elastically supported.

46. The bulk goods dryer according to claim 41, wherein the filter elements of the at least two chambers comprise elevations and depressions.

47. The bulk goods dryer according to claim 41, wherein the impulse generators of the at least two chambers are separately controllable.

48. The bulk goods dryer according to claim 41, further comprising a twin screw granulator arranged upstream of the product inlet, wherein the twin screw granulator comprises an inlet for a liquid and an inlet for a powder product material.

49. The bulk goods dryer according to claim 41, wherein the vibration drive is an electric motor drive and is configured to vibrate the fluid medium-permeable inflow bottom in a flow direction of the product and transverse to the flow direction of the product.

50. The bulk goods dryer according to claim 41, further comprising springy supports supporting the fluid medium-permeable inflow bottom.

51. The bulk goods dryer according to claim 50, wherein the springy supports are spiral springs.

52. The bulk goods dryer according to claim 41, wherein the vibration drive is arranged at a side wall of the reactor chamber.

53. The bulk goods dryer according to claim 41, wherein a fixed bed of the product forms on the fluid medium-permeable inflow bottom.

54. The bulk goods dryer according to claim 41, wherein the control unit is configured to actuate the impulse generators of the at least two chambers as a function of a position of the shut-off members.

55. The bulk goods dryer according to claim 41, wherein the fluid medium-permeable inflow bottom is a vibration filter screen.

56. The bulk goods dryer according to claim 55, wherein the vibration filter screen is a stainless steel filter fabric screen.

57. The bulk goods dryer according to claim 41, further comprising a rotary valve connected of the product outlet, wherein the product is dispensed through the rotary valve.

58. The bulk goods dryer according to claim 41, wherein impulse generators of the at least two chambers are ultrasonic generators generating ultrasonic waves in a selectable frequency range.

59. The bulk goods dryer according to claim 58, wherein the ultrasonic generators generate ultrasonic waves as a function of predetermined operating parameters by an implemented control software in an optimized frequency range.

60. The bulk goods dryer according to claim 59, wherein the ultrasonic generators in predetermined operating intervals during operation of the bulk goods dryer generate ultrasonic waves when the shut-off members have shut off the flow of the fluid medium through the correlated chamber.
